(19) United States
(12) Patent Application Publication
(10) Pub. No.: US 2010/0197269 A1
(43) Pub. Date: Aug. 5, 2010

(54) APPARATUS AND METHOD FOR MANAGING SECURE INFORMATION IN A MOBILE TERMINAL

(75) Inventors: Jin-Woo NAM, Seoul (KR); Hyun-Woo KIM, Gyeongbuk (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/628,373

(22) Filed: Dec. 1, 2009

(30) Foreign Application Priority Data
Feb. 3, 2009 (KR) 10-2009-0008475

(51) Int. Cl. G06F 21/00; H04M 3/16

(52) U.S. Cl. 455/410; 726/26

(57) ABSTRACT

To manage secure information in a mobile terminal, a method for storing the secure information in the mobile terminal includes locating initial bad blocks in a memory of the mobile terminal. A location of a secure block is determined using the locations of the initial bad blocks; and the secure information is stored to a secure block of the determined location.

### CLAIM OF PRIORITY

This application claims the benefit of priority under 35 U.S.C. §119 from patent application No. 10-2009-0008475 filed in the Korean Intellectual Property Office on Feb. 3, 2009, the contents of which is hereby incorporated by reference in its entirety in its entirety.

### BACKGROUND OF THE INVENTION

1. Field of the Invention

The present invention relates generally to a mobile terminal. More particularly, the present invention relates to an apparatus and a method for managing secure information in the mobile terminal so that it is protected from unauthorized users.

2. Description of the Related Art

A mobile terminal has a memory for storing an Operating System (OS), application, booting code, and a file system essential for operations of the mobile terminal. The mobile terminal also stores secure information, such as International Mobile Equipment Identity (IMEI) or network information, which should be protected from unauthorized users, to the memory.

Typically, in mobile terminals of the same model or the same platform, the physical location of the secure information stored to the memory is identical. In order to protect against the illegal access to the secure information, encryption and authentication are applied for access to the secure information. However, since the location of the stored secure information is identical in the same model or platform of mobile terminals, the secure information is highly likely to be exposed to the attack of the illegal users. That is, once the illegal user accesses the secure information in one terminal, he or she can access the secure information in every mobile terminal of the same model or the same platform. In this regard, there is a need in the art to protect the secure information more effectively.

### SUMMARY OF THE INVENTION

An aspect of the present invention is to provide at least the advantages described below by providing an apparatus and a method for protecting secure information in a mobile terminal.

Another aspect of the present invention is to provide an apparatus and a method for determining a location of a secure block using locations of initial bad blocks in a mobile terminal.

Yet another aspect of the present invention is to provide an apparatus and a method for using a memory regardless of a location of a secure block in a mobile terminal.

According to still another aspect of the present invention, a method for storing secure information in a mobile terminal preferably includes locating initial bad blocks in a memory; determining a location of a secure block using the locations of the initial bad blocks; and storing secure information to a secure block of the determined location.

According to even another aspect of the present invention, a method for operating a mobile terminal preferably includes when access to secure information is required, locating initial bad blocks in a memory; determining a location of a secure block using the locations of the initial bad blocks; and loading, modifying, or deleting secure information stored to the secure block of the determined location.

According to an additional aspect of the present invention, an apparatus of a mobile terminal preferably includes a manager for, when access to secure information is required, locating initial bad blocks in a memory; and an accessor for determining a location of a secure block using the locations of the initial bad blocks, and loading, modifying, or deleting secure information stored to the secure block of the determined location.

Other exemplary aspects, advantages and salient features of the invention will become more apparent to those skilled in the art from the following detailed description, which, taken in conjunction with the annexed drawings, discloses exemplary embodiments of the invention in more detail.

### BRIEF DESCRIPTION OF THE DRAWINGS

The above and other aspects, features and advantages of certain exemplary embodiments the present invention will become more apparent from the following detailed description when taken in conjunction with the accompanying drawings, in which:

FIG. 1 is a diagram of an initial bad block distribution of a memory of a mobile terminal;

FIG. 2 is a diagram of the memory configuration of the mobile terminal according to an exemplary embodiment of the present invention;

FIG. 3 is a flowchart of a method for storing secure information to the mobile terminal according to an exemplary embodiment of the present invention;

FIG. 4 is a block diagram of the mobile terminal according to an exemplary embodiment of the present invention; and

FIG. 5 is a flowchart of a method for accessing the secure information in the mobile terminal according to an exemplary embodiment of the present invention.

Throughout the drawings, like reference numerals will be understood to refer to like or similar parts, components and structures.

### DETAILED DESCRIPTION

The following description, with reference to the accompanying drawings, is provided to assist a person of ordinary skill in the art with a comprehensive understanding of exemplary embodiments of the present invention as defined by the appended claims. The description includes various specific details for illustrative purposes to assist in that understanding but these details are to be regarded as merely exemplary. Accordingly, those of ordinary skill in the art will recognize that various changes and modifications of the exemplary embodiments described herein can be made without departing from the scope and spirit of the invention as defined by the appended claims. Also, descriptions of well-known functions and constructions may be omitted for conciseness and so as not to obscure appreciation of the present invention by a person of ordinary skill with such well-known functions and constructions.

Exemplary embodiments of the present invention provide a technique for protecting secure information in a mobile terminal. Hereinafter, the mobile terminal represents cellular phones, Personal Communication Systems (PCSs), Personal Data Assistant (PDAs), and International Mobile Telecommunication (IMT)-2000 terminals.

Not AND (NAND) flash memory, which is one of memories used in the mobile terminal, is shipped from the factory with at least one bad block according to its characteristic. The bad block indicates a block in which data cannot be written. Hereafter, the bad block in the memory manufacturing process is referred to as an initial bad block. By determining a storage location of secure information using the initial bad block, the present invention protects secure information against illegal accesses.

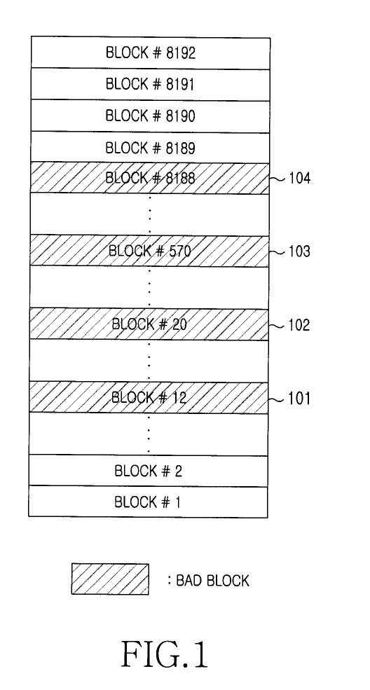

For instance, according to the present invention, the initial bad blocks in the memory can be distributed as shown in FIG. 1. In FIG. 1, four initial bad blocks 101 through 104 are present in total 8192 blocks. In this particular example, the initial bad blocks 101 through 104 are positioned at #12, #20, #570 and #8188 respectively. The location of a secure block for storing the secure information is determined using offset values of the initial bad blocks.

For example, the location of the secure block can be determined based on Equation (1):

$${SB}_{offset} = \frac{\sum {BB}_{offset}}{{N}_{BB}} \qquad ( 1 )$$

In Equation (1), SB_{offset} denotes an offset of the secure block, BB_{offset} denotes an offset of the initial bad block, and N_{BB} denotes the number of the initial bad blocks.

According to Equation (1), the location of the secure block is #2188 (=(12+20+570+8118/4) in FIG. 1. Naturally, when the locations of the initial bad blocks in the embedded memory are different even in the same model or platform, the storage location of the secure information varies in each mobile terminal. Thus, an unauthorized user cannot obtain the secure information on another mobile terminal just because they know the location of the secure information on a particular phone that was compromised.

However, as the location of the secure block is not fixed, the mobile terminal needs to take into account the location of the secure block every time it uses the memory. In other words, the mobile terminal should write new data to other blocks than the secure block. The determination of the secure block location in every memory access to take into account the location of the secure block increases unnecessary computations of the mobile terminal. Thus, the present invention manages the secure block like the bad block.

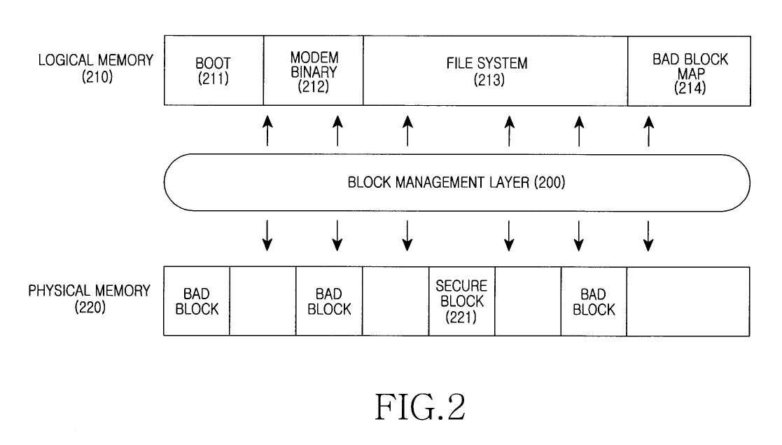

When an upper layer such as an application and Operating System (OS) uses the memory, the upper layer accesses a logical memory 210 through a Block Management Layer (BML) 200 as shown in FIG. 2. The logical memory 210 includes a boot 211 including a microcode used to boot up the mobile terminal, a modem binary 212 including the application and the OS, a file system 213 including information for file input and output, and a bad block map 214 indicating the locations of the bad blocks. In the logical memory 210, while the boot 211, the modem binary 212, the file system 213, and the bad block map 214 are the consecutive blocks, blocks of a physical memory 220 corresponding to those blocks of the logical memory 210 may not be consecutive. Accordingly, the BML 200 manages the mapping relation between the logical memory 210 and the physical memory 220 and allows the upper layer to access the physical memory 220 through the logical memory 210. The BML 220 manages the secure block 221 as being a bad block and defines the secure block 221 as a bad block in the bad block map 214. As the secure block 221 is set as the bad block, the upper layer accessing the memory can attain the linear memory space for the boot 211, the modem binary 212, and the file system 213 without noticing the secure block 221.

Now, a method for storing the secure information and a structure and operations of the mobile terminal constituted as above are described in detail by referring to the drawings.

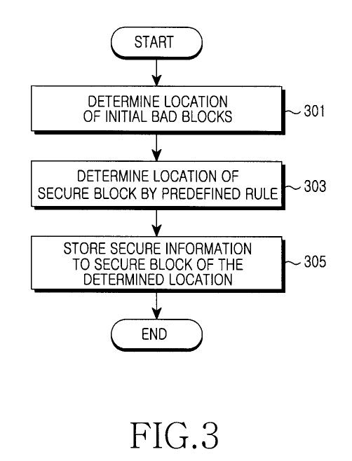

FIG. 3 is a flowchart showing exemplary operation of a method for storing the secure information to the mobile terminal according to an exemplary embodiment of the present invention. Typically, the method for storing the secure information of FIG. 3 is carried out when the mobile terminal is manufactured. However, when the secure information is changed during the operations of the mobile terminal, the method of FIG. 3 can be performed again during the process of the operations of the mobile terminal. To ease in the understanding of this aspect of the present invention, a subject who stores the secure information is referred to as a secure information storer.

In FIG. 3, the secure information storer determines locations of the initial bad blocks in the memory in step 301. Herein, the initial bad block is the bad block produced in the manufacture of the memory. The location is expressed with an address value or an offset value.

In step 303, the secure information storer determines the location of the secure block according to a predefined rule. More specifically, the secure information storer determines the location of the secure block using the locations of the initial bad blocks obtained in step 301. For example, when the location is expressed with the offset value, the secure information storer determines the offset of the secure block based on Equation (1).

In step 305, the secure information storer then stores the secure information to the secure block. The secure information occupies only one block corresponding to the location of the secure block determined in step 303, or a plurality of blocks including the one block. For example, the secure information includes at least one of International Mobile Equipment Identity (IMEI) and network information.

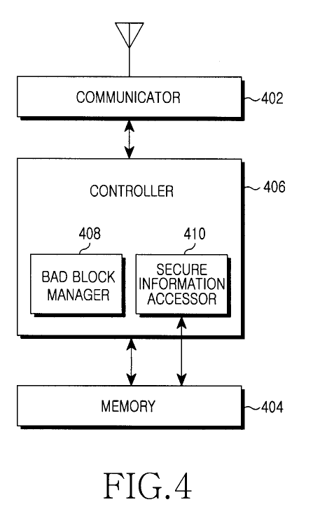

FIG. 4 is a block diagram of the mobile terminal according to an exemplary embodiment of the present invention. Referring now to FIG. 4, the mobile terminal of FIG. 4 preferably includes a communicator 402, a memory 404, and a controller 406.

The communicator 402 provides the interface for communications over a radio channel. In more detail, the communicator 402 performs mutual conversion between information data and transmitted and received signals according to the system standard. More specifically, the communicator 402 typically converts a bit stream output from the controller 406 to a physical Radio Frequency (RF) signal and transmits the RF signal over an antenna, and converts a physical RF signal received over the antenna to a bit stream and provides the bit stream to the controller 406.

The memory 404 stores a microcode, application, OS, and contents required for the operations of the mobile terminal. For example, the memory 404 can be implemented using a NAND flash. The memory 404 includes the secure blocks determined using the locations of the initial bad blocks in the memory 404, and stores the secure information of the secure blocks. For example, the location of the secure block is determined based on Equation (1).

The controller 406 typically controls the operations of the mobile terminal. By way of example, the controller 406 generates the transmit data and executes a function corresponding to the received data. The controller 406 executes the microcode, the application, or the OS for the operations and stores the generated information to the memory 404. Particularly, the controller 406 includes a bad block manager 408 for managing the bad blocks in the memory 404, and a secure information accessor 410 for processing the secure information.

The bad block manager 408 stores the information relating to the locations and the number of the bad blocks in the memory 404, and sets a new bad block. The bad block manager 408 designates the secure block in the memory 404 as the bad block. Hence, the application and the OS executed by the controller 406 recognize the secure block as the bad block and can use the memory 404 without considering the secure block.

Still referring to FIG. 4, the secure information accessor 410 determines the location of the secure block in the memory 404, and loads, modifies or deletes the secure information stored to the secure block in the memory 404 for the authorized access only. In so doing, the secure information accessor 410 determines the location of the secure block by predefined rule using the locations of the initial bad blocks. For example, the secure information accessor 410 determines the location of the secure block based on Equation (1).

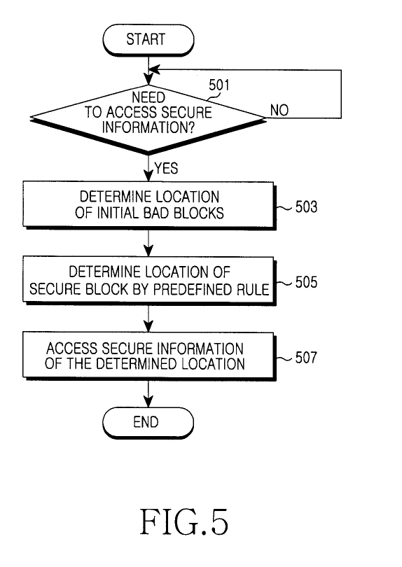

FIG. 5 is a flowchart showing exemplary operation of a method for accessing the secure information in the mobile terminal according to an exemplary embodiment of the present invention.

In step 501, the mobile terminal determines whether it is necessary to access the secure information. That is, the mobile terminal determines whether to load, delete, or modify the secure information. For instance, the loading of the secure information is required for the boot-up of the mobile terminal.

When the access to the secure information is required, the mobile terminal determines locations of the initial bad blocks in the memory in step 503. Herein, the initial bad block is the bad block produced during the manufacture of the memory. The location is expressed with the address value or the offset value.

After locating the positions of the initial bad blocks, the mobile terminal determines the location of the secure block by the predefined rule in step 505. That is, the mobile terminal determines the location of the secure block using the locations of the initial bad blocks confirmed in step 503. For example, when the location is expressed with the offset value, the mobile terminal determines the offset of the secure block based on Equation (1).

In step 507, the mobile terminal accesses the secure information at the determined location in step 507. In more detail, the mobile terminal loads, modifies, or deletes the secure information stored to the secure block residing at the determined location. The secure information occupies only one block corresponding to the determined location, or a plurality of blocks including the one block.

A result of the mobile terminal determining the storage location of the secure information based on the addresses of the initial bad blocks in the memory, the protection of the secure information against unauthorized and/or illegal accesses is increased to a greater level than known heretofore.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a special processor or in programmable or dedicated hardware, such as an ASIC or FPGA, etc. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for storing secure information in a mobile terminal, comprising:
determining locations of initial bad blocks in a memory;
determining a location of a secure block in the memory using the locations of the initial bad blocks; and
storing secure information to a secure block in the determined location of said secure block.

2. The method of claim 1, wherein the location of the secure block is determined according to the following formula:
$${SB}_{offset} = \frac{\sum {BB}_{offset}}{{N}_{BB}} ;$$
wherein, SB_{offset} denotes an offset of the secure block, BB_{offset} denotes an offset of an initial bad block, and N_{BB} denotes a number of the initial bad blocks.

3. The method of claim 1, wherein the memory comprises a Not AND (NAND) flash memory.

4. The method of claim 1, wherein the location of the secure block is determined by dividing a sum of the locations of the initial bad blocks by the number of the initial bad blocks.

5. The method of claim 1, wherein the secure information includes at least one of an International Mobile Equipment Identity (IMEI) and network information.

6. The method of claim 1, wherein the locations of the initial bad blocks in memory is expressed with one of an address value and an offset value.

7. The method of claim 1, wherein a controller having a bad block manager manages the initial bad blocks in the memory, and a secure information accessor processes the secure information.

8. The method according to claim 7, wherein the bad block manager stores the information relating to the locations and a number of the initial bad blocks in the memory, and sets a new bad block.

9. The method according to claim 8, wherein the bad block manager designates the secure block in the memory as the new bad block.

10. The method of claim 9, wherein an application and an operating system controlled by the controller recognizes the secure block as the bad block and can uses the memory without considering the secure block.

11. A method for operating a mobile terminal, comprising:
locating initial bad blocks in a memory when access to secure information is required;
determining a location of a secure block using the locations of the initial bad blocks; and
loading, modifying, or deleting secure information stored to the secure block of the determined location.

12. The method of claim 11, wherein the location of the secure block is determined by dividing a sum of the locations of the initial bad blocks by the number of the initial bad blocks.

13. The method of claim 11, wherein a designation of the secure block is set to a bad block.

14. An apparatus of a mobile terminal, comprising:
a bad block manager for determining locations of initial bad blocks in a memory when access to secure information is required; and
an accessor for determining a location of a secure block in the memory using the locations of the initial bad blocks, and loading, modifying, or deleting secure information stored to the secure block of the determined location.

15. The apparatus of claim 14, wherein the location of the secure block is determined by dividing a sum of the locations of the initial bad blocks by the number of the initial bad blocks.

16. The apparatus of claim 14, wherein the bad block manager sets a designation of the secure block to that of a bad block.

17. The apparatus of claim 14, wherein the memory comprises a Not AND (NAND) flash memory.

18. The apparatus of claim 15, wherein the locations of the initial bad blocks in memory is expressed with one of an address value and an offset value.

19. The apparatus of claim 14, wherein the location of the secure block is determined according to the following formula:
$${SB}_{offset} = \frac{\sum {BB}_{offset}}{{N}_{BB}} ;$$
wherein, SB_{offset} denotes an offset of the secure block, BB_{offset} denotes an offset of an initial bad block, and N_{BB} denotes a number of the initial bad blocks.
